(19) United States
(12) Patent Application Publication
(10) Pub. No.: US 2015/0027837 A1
(43) Pub. Date: Jan. 29, 2015

(54) RAIL SYSTEM HAVING AN ENERGY EXCHANGE STATION

(71) Applicant: Electro-Motive Diesel, Inc., La Grange, IL (US)

(72) Inventor: Harinder Singh Lamba, Downers Grove, IL (US)

(73) Assignee: Electro-Motive Diesel, Inc., La Grange, IL (US)

(21) Appl. No.: 13/953,103

(22) Filed: Jul. 29, 2013

(51) Int. Cl. B60L 9/00

(52) U.S. Cl. CPC B60L 9/00
USPC 191/6

(57) ABSTRACT

A rail system is disclosed. The rail system may have a track including a powered section and an unpowered section. The rail system may also have an electrical contact that extends along the powered section of the track. The rail system may further have an energy exchange station electrically connected to the electrical contact. The energy exchange station may be configured to initiate power transmission between the energy exchange station and a rail vehicle, through the electrical contact, when the rail vehicle is on the powered section of the track. The energy exchange station may also be configured to discontinue power transmission between the energy exchange station and the rail vehicle when the rail vehicle leaves the powered section of the track.

### TECHNICAL FIELD

The present disclosure is directed to a rail system and, more particularly, to a rail system having an energy exchange station.

### BACKGROUND

Rail systems include locomotives and other vehicles that move throughout various interconnected regions to transport people and cargo. The vehicles are driven by an independent power source, such as a combustion engine that provides mechanical energy to drive the train. Locomotives with combustion engines produce on-demand power to meet varying load requirements of the train. However, fuel for these engines (e.g., diesel fuel) is expensive and often produces environmentally-harmful exhaust as a combustion by-product.

Electrically-powered locomotives provide an alternative to combustion engines. An exemplary electric rail system is described in European Patent Document EP 2505416 A1 (“the '416 patent”), published on Oct. 3, 2012. The rail system of the '416 patent includes vehicles that are electrically powered by a global infrastructure composed of overhead power lines. A control system monitors speed and load information of the moving vehicles and provides instructions to increase or decrease the speed of particular vehicles to balance an overall load on the electrical power supply system with the amount of electrical energy actually supplied.

While the rail system of the '416 patent may provide an alternative to engine-driven systems, it may suffer from some drawbacks. For example, the rail system disclosed in the '416 patent relies on a large infrastructure to provide electrical power to the vehicles. This includes installation and maintenance of overhead lines that run along the entire length of the rail system, which can be very expensive.

In general, capital expenses associated with electric rail systems are often excessive since electrically-powered vehicles require a large infrastructure to supply an electrical power source (e.g., overhead lines) to the entire track. In addition, the power supplied to the vehicles often originates from a conventional power supply (e.g., power plant) that also may be unfriendly to the environment. Therefore, a need exists for an alternative rail system that overcomes these problems.

The present disclosure is directed to overcoming one or more of the problems set forth above and/or other problems of the prior art.

### SUMMARY

In one aspect, the present disclosure is directed to a rail system. The rail system may include a track including a powered section and an unpowered section. The rail system may also include an electrical contact that extends along the powered section of the track. The rail system may further include an energy exchange station electrically connected to the electrical contact. The energy exchange station may be configured to initiate power transmission between the energy exchange station and a rail vehicle, through the electrical contact, when the rail vehicle is on the powered section of the track. The energy exchange station may also be configured to discontinue power transmission between the energy exchange station and the rail vehicle when the rail vehicle leaves the powered section of the track.

In another aspect, the present disclosure is directed to a method of operating a rail system. The method may include connecting an electrical contact to a rail vehicle while the rail vehicle travels on a powered section of a track. The method may also include initiating power transmission between an energy exchange station and the rail vehicle, through the electrical contact, while the rail vehicle travels on the powered section of the track. The method may further include discontinuing power transmission between the energy exchange station and the rail vehicle and disconnecting the electrical contact from the rail vehicle when the rail vehicle leaves the powered section of the track.

### BRIEF DESCRIPTION OF THE DRAWINGS

FIG. 1 depicts a schematic illustration of an exemplary disclosed rail system; and

FIG. 2 illustrates an exemplary vehicle, energy exchange station, and control system that may be used in conjunction with the rail system of FIG. 1.

### DETAILED DESCRIPTION

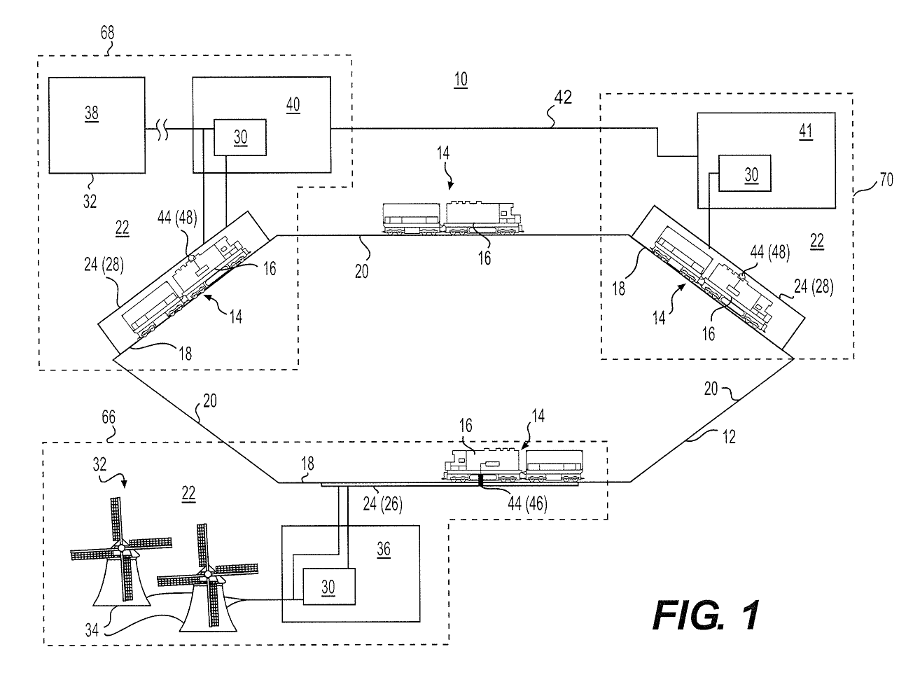

FIG. 1 schematically illustrates an exemplary rail system 10 consistent with certain disclosed embodiments. Rail system 10 may include a network of tracks 12 that support various vehicles 14. Tracks 12 may be any type of transportation pathway, such as railroad tracks, subway rails, trolley tracks, etc., on which vehicles 14 may travel. Tracks 12 may be interconnected or separated, such that some vehicles 14 travel only on some tracks 12 and other vehicles 14 travel only on other tracks 12. Each vehicle 14 may be any type of vehicle capable of traveling on tracks 12. For example, vehicles 14 may be rail vehicles such as locomotives, railcars (e.g., freight and/or passenger railcars), subway cars, trolley cars, etc. Vehicles 14 may be arranged into consists (e.g., trains) or operate independently.

In an exemplary embodiment, each vehicle 14 may include an electrically-powered locomotive 16. Locomotive 16 may be arranged to be primarily operated with an electrical power system, but may include a mechanical power source, such as a diesel engine, as a backup power system in case of failure or unavailability of the electrical power system. In other embodiments, locomotive 16 may run on a combination electrical and mechanical power system (e.g., a diesel-electric locomotive). Locomotive 16 may be configured to convert electrical energy into mechanical energy to produce tractive power to move vehicle 14 along track 12, such as through traction motors (not shown).

Rail system 10 may be arranged to provide electrical energy to locomotives 16 for use in traveling on tracks 12. In the exemplary rail system 10 depicted in FIG. 1, track 12 may include a plurality of powered sections 18 and a plurality of unpowered sections 20. Each powered section 18 may be configured to provide electrical energy to locomotives 16 within the powered section 18 for immediate and/or eventual use in driving locomotive 16 on track 12. Locomotives 16 traveling in unpowered sections 20 may need to rely on onboard power sources or stored energy to provide power to drive locomotive 16 on track 12 within a respective unpowered section 20. In some embodiments, a length of the unpowered sections 20 may be much greater than a length of the powered sections 18. In other words, powered sections 18 may only make up relatively short portions of track 12, as compared to unpowered sections 20. For example, a given powered section 18 may be only a few miles long, while an unpowered section 20 may be hundreds of miles long or even greater.

Powered sections 18 may be configured to provide electrical energy to locomotives 16 via one or more energy exchange stations 22 situated at various locations near track 12. Each energy exchange station 22 may include an electrical contact 24 located near the portion of track 12 within the respective powered section 18. Electrical contact 24 may be an offboard device configured to transmit and/or receive electrical energy to or from another contact device. For example, electrical contact 24 may be an electrified rail 26 (e.g., third rail), overhead power line 28 (e.g., catenary), or other device configured to act as an electrical power source to which locomotives 16 may connect. Electrical contact 24 may extend along only the associated powered section 18 of track 12. Energy exchange stations 22 may include various components configured to supply electrical power to electrical contact 24. These components may include one or more energy storage devices 30 and/or one or more power sources 32.

Energy storage devices 30 may be arranged to store electrical energy. For example, energy storage devices 30 may include one or more rechargeable batteries configured to receive, store, and transmit electrical energy. In other embodiments, energy storage device 30 may include a mechanical storage system, such as a hydrogen storage system or a mechanical flywheel. A combination of electrical and mechanical energy storage devices 30 is also possible.

Each power source 32 may be any system or device configured to generate electrical energy (or mechanical energy that can be converted into electrical energy) for supplying electrical energy to electrical contacts 24. In an exemplary embodiment, power source 32 may be a renewable energy source 34. Renewable energy source 34 may be configured to generate electrical energy by harnessing one or more types of renewable energy. For example, renewable energy source 34 may be configured to utilize wind or solar energy to produce electrical energy, such as through a wind turbine or solar panel. In other embodiments, renewable energy source 34 may be a bio-fuel generator configured to produce electrical energy via bio-fuel energy.

Renewable energy source 34 may be located near the corresponding powered portion 18 of track 12. The area near the powered portion 18 may be considered in determining the type of renewable energy source 34 to be utilized for the corresponding energy exchange station 22. For example, a large, open area near track 12 may be utilized for a wind or solar farm. An area with a body of water near track 12 may utilize a hydro-powered or tidal energy source to supply electrical energy to a powered portion 18.

Regardless of the type of renewable energy source 34, the electrical energy generated may be directed to a trackside location 36 and transformed into a form suitable for storage in energy storage device 30 and/or immediate use at electrical contact 24. In this way, electrical energy from renewable energy source 34 may be accumulated and stored for eventual use in energy storage device 30, even when production of the electrical energy is variable (e.g., solar energy, wind energy, etc.).

It is also contemplated that power source 32 may be a conventional source of electrical energy, such as a power substation 38 that receives electrical energy from a power grid (e.g., energy originating from a power plant that supplies electrical energy to a particular region). The electrical energy from the power grid may be diverted to a trackside location 40 and transformed into a form suitable for storage in energy storage device 30 and/or immediate use at electrical contact 24.

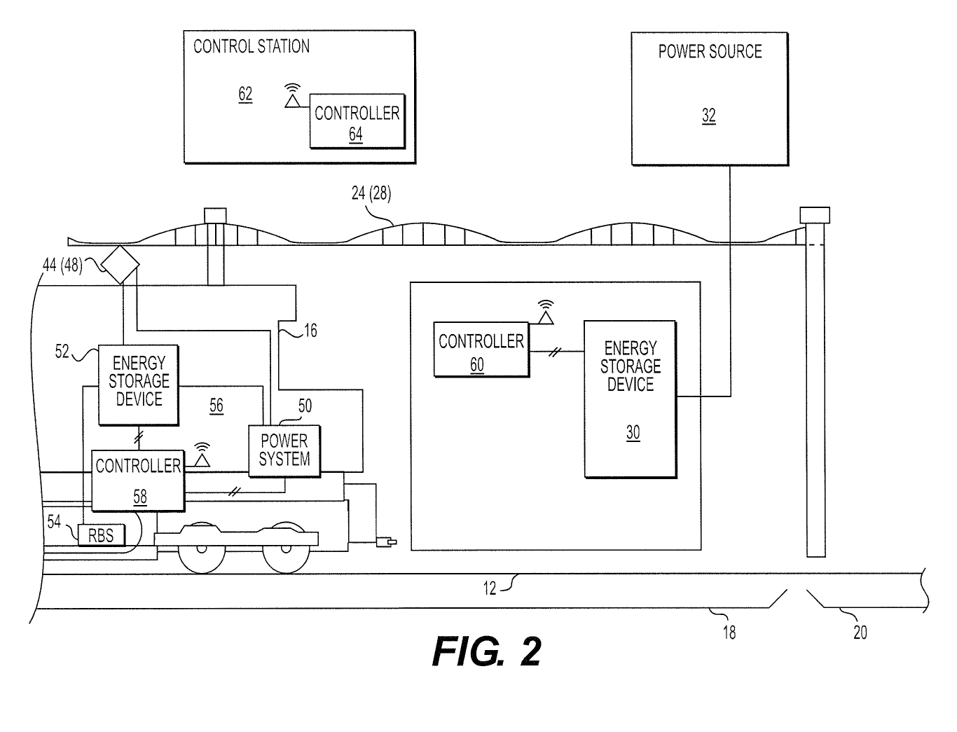

In other embodiments, energy exchange station 22 may include an energy storage device 30 that is not coupled to a local power source. In this embodiment, energy exchange station 22 may receive electrical energy from a connected locomotive 16 utilizing a regenerative braking system (RBS) 54 (shown only in FIG. 2). The electrical energy received from locomotive 16 may be stored at a trackside location 41 in an energy storage device 30 and directed back to the same or another locomotive 16 when needed. It is further possible that electrical energy from one locomotive 16 utilizing RBS 54 may be directed to another locomotive 16 connected to the same electrical contact 24 without ever being stored in energy storage device 30.

In some embodiments, energy exchange stations 22 may be interconnected by a global exchange system 42. Global exchange system 42 may allow energy sharing between energy exchange stations 22. For example, electrical energy generated by an RBS 54 of a locomotive 16 connected to one electrical contact 24 may be directed to one energy exchange station 22 and subsequently supplied to another energy exchange station 22 via global exchange system 42 for storage and/or use by another locomotive 16 connected to the associated electrical contact 24. Global exchange system 42 may connect selected energy exchanges stations 22 via directly-connected power lines, a larger power grid, or other type of electrical connection known in the art.

FIG. 1 further depicts several exemplary configurations of energy exchange stations 22. For example, energy exchange stations 22 may include energy exchange stations 66, 68, and 70. Energy exchange station 66 may include electrical contact 24, energy storage device 30 and power source 32. Power source 32 may be renewable energy source 34.

Energy exchange station 68 may be arranged in the same manner as energy exchange station 66, except power source 32 may be a connection to a power grid, such as through power substation 38. Power substation 38 may transmit electrical energy to trackside location 40 for storage in energy storage device 30. Energy storage device 30 may subsequently transmit electrical energy to locomotives 16 that are passing through the powered section 18 associated with energy exchange station 68.

Energy exchange station 70 is an exemplary energy exchange station 22 that includes an energy storage device 30, but does not necessarily include a power source 32. Energy storage device 30 may receive enough electrical energy from passing locomotives 16 (e.g., via RBS 54) to be transmitted back to other locomotives 16. In some embodiments, energy exchange station 70 may act as a power source. For example, energy exchange station 70 may act as a power source for energy exchange station 68 by directing electrical energy through global exchange system 42.

In some embodiments, powered sections 18 and associated energy exchange stations 22 may be strategically located to take advantage of certain aspects of track 12. For example, energy exchange station 66 may be placed near a train station. In this way, locomotive 16 may be configured to conveniently utilize RBS 54 to transmit electrical energy from locomotive 16 to energy exchange station 66, such as when locomotive 16 approaches the train station. In one embodiment, a locomotive 16 that is slowing down to stop at the train station may produce electrical energy via RBS 54 and transmit that electrical energy to energy storage device 30. Energy storage device 30 may subsequently direct the electrical energy to another locomotive 16 that may be ready to depart or in the process of departing the train station. In this way, energy may be conveniently shared between locomotives 16. It should be understood that locomotives 16 may share electrical energy without directing energy to energy storage device 30 (i.e., sharing electrical energy directly via electrical contact 24).

Similarly, some energy exchange stations 22 (e.g., energy exchange stations 68 and/or 70) may be located on a grade (e.g., hill, mountainous area, etc.). Locomotives 16 that are slowing down to traverse down-grade may produce energy via RBS 54 to be transmitted to a locomotive 16 that is traveling up-grade.

Powered sections 18 may also be strategically located in relation to unpowered sections 20. For example, powered section 18 may be located such that locomotives 16 may receive enough energy from a powered section 18 to traverse the adjacent unpowered section 20 efficiently. That is, powered sections 18 may be spaced such that locomotives 16 may be charged with enough energy to travel to the next powered section 18 without risk of running out of power or arriving with an oversupply of energy that may create an imbalance of energy between energy exchange stations 22.

Locomotives 16 may connect to electrical contact 24 of an energy exchange station 22 for transfer of electrical energy through an electrical contact 44 on locomotive 16 (or an attached railcar). Electrical contact 44 may be an onboard device configured to selectively connect to electrical contact 24 when locomotive 16 is within a powered section 18 of track 12. For example, electrical contact 44 may be a charging shoe 46 for use with electrified rail 26, a pantograph 48 for use with overhead power lines 28, or other pickup device configured to create an electrical connection with electrical contact 24. Electrical contact 44 may be arranged to be automatically connected to electrical contact 24 when locomotive 16 enters a powered section 18, or may await an instruction from an operator or control system.

FIG. 2 depicts an exemplary locomotive 16 connected to a powered section 18 of rail system 10. Locomotive 16 may include a power system 50. Power system 50 may include one or more electric motors configured to utilize electrical energy to power traction devices located on locomotive 16 to drive locomotive 16 and any attached rail vehicles on track 12. Power system 50 may be electrically connected to electrical contact 44 such that electrical energy may be supplied to power system 50 through electrical contact 44. In this way, energy from an energy exchange station 22 may be transmitted directly to power system 50 to drive locomotive 16.

In addition to power system 50, locomotive 16 (or a connected railcar), may include one or more energy storage devices 52 for storing energy onboard vehicle 14. In an exemplary embodiment, energy storage devices 52 may include one or more rechargeable batteries configured to receive, store, and transmit electrical energy. In other embodiments, energy storage device 52 may include a mechanical storage system, such as a hydrogen storage system or a mechanical flywheel. A combination of electrical and mechanical energy storage devices 52 is also possible. Energy storage device 52 may be electrically connected to electrical contact 44 and power system 50. In this way, energy storage device 52 may be charged by energy from electrical contact 44 and discharged by power system 50 to drive locomotive 16.

Locomotive 16 may also include a regenerative braking system (RBS) 54. RBS 54 may be configured to convert mechanical energy produced during a braking operation of locomotive 16 (or connected railcar) into electrical energy, in a manner known in the art. RBS 54 may be connected to one or more of electrical contact 44, power system 50, and energy storage device 52. The electrical energy generated by RBS 54 may be transferred to any of these components. For example, electrical energy produced by RBS 54 may be directed to electrical contact 44 for transfer off of locomotive 16, to power system 50 for driving locomotive 16, and/or to energy storage device 52 for increasing the supply of stored energy onboard locomotive 16.

As further depicted in FIG. 2, rail system 10 may include one or more control systems 56 configured to electronically control components of rail system 10. Locomotive 16 and energy exchange station 22 may each include a controller 58, 60, respectively. Control system 56 may also include a control station 62 with a controller 64. Controllers 58, 60, 64 may be connected to each other via a wireless network, such that each can electronically communicate with each other. In other embodiments, one or more controllers 58, 60, and 64 may be connected via a wired connection.

Controllers 58, 60, 64 may each include one or more computing devices such as one or more microprocessors. For example, each controller 58, 60, 64 may embody a general microprocessor capable of controlling numerous machine or engine functions. Each controller 58, 60, 64 may also include all of the components required to run an application such as, for example, a computer-readable memory, a secondary storage device, and a processor, such as a central processing unit or any other means known. Various other known circuits may be associated with controllers 58, 60, 64, including a power source and other appropriate circuitry.

Control station 62 may be a global control center configured to oversee operation of rail system 10. For example, control station 62 may include systems and/or operators that monitor and control locomotives 16, energy exchange stations 22, and other onboard and offboard equipment. In other embodiments, control station 62 may be a local control center configured to control operation of a particular energy exchange station 22 and locomotives 16 that pass through or nearby. Control station 62 may be part of an overall rail control system known in the art, such as positive train control and/or automated train control systems.

In the exemplary disclosed embodiment, control system 56 may include processes and operations to coordinate energy sharing between energy exchange stations 22 and locomotives 16. As has been described, each powered section 18 of track 12 may include an energy exchange station 22 that is configured to transmit energy to and receive energy from locomotives 16 that are connected to energy exchange station 22 via electrical contacts 24 and 44. Control system 56 may implement various control processes and operations to determine energy requirements of components of rail system 10 and distribute the available energy accordingly. Exemplary processes consistent with these embodiments are described in more detail below.

### INDUSTRIAL APPLICABILITY

The disclosed embodiments may be applicable to any transportation system in which electrical energy is supplied to power a vehicle. The disclosed rail system 10 may be applicable to an existing or new rail system. Existing rail systems may be modified or new rail systems may be constructed to include energy exchange stations, which may be beneficial, for example, by allowing different rail vehicles to share electrical energy. In addition, the energy exchange stations may be configured to receive energy from renewable energy sources, such as solar, wind and bio-mass generators, that store energy in energy storage devices at an energy exchange station and provide such energy to locomotives that are on a powered section of the track. By storing large amounts of energy at the energy exchange station, energy storage devices on the locomotive may be charged rapidly while the locomotive is moving. In this way, locomotives do not have to be stationary, and hence unused, in order for their onboard electrical energy storage devices to be recharged with sufficient electrical energy to travel on unpowered sections of the track. Further, the inclusion of the unpowered sections with relatively short powered sections may reduce the infrastructure required to provide power to rail vehicles in the rail system, since rail vehicles may be powered by stored electrical energy when traveling on the unpowered section of the track. Exemplary processes for using the disclosed rail system 10 to achieve these benefits are described in more detail below.

Power sources 32 may produce electrical energy for use in powering locomotives 16 within rail system 10. In some embodiments, the electrical energy from power sources 32 may be made immediately available to locomotives 16 via direct connections to an electrical contact 24 within a powered section 18. Alternatively or in addition, electrical energy from power sources 32 may be stored in an energy storage device 30 prior to being transmitted to electrical contact 24.

For example, a power source 32, which may be renewable energy source 34, may produce electrical energy at various times (e.g., via solar energy when the sun is shining). The electrical energy may be accumulated in energy storage device 30, such that a relatively large quantity of electrical energy is made available at an associated energy exchange station 22. As a locomotive 16 continues to travel on track 12, through a powered section 18, energy storage device 30 may rapidly transmit electrical energy, for storage onboard or immediate use, to locomotive 16.

As a locomotive 16 approaches an energy exchange station 22 (e.g., energy exchange station 66), a controller (e.g., one of controllers 58, 60, 64) may determine an energy state of energy storage device 30 and/or energy storage device 52 onboard locomotive 16. The energy state may be a current energy storage capacity of the energy storage device 30 and/or 52. Based on the determined energy state, the controller may determine a transmission path. For example, the transmission path may be from energy exchange station 22 to locomotive 16 or from locomotive 16 to energy exchange station 22. In other embodiments, the transmission path may be from one locomotive 16 to another locomotive 16.

In one exemplary process, controller 58 may determine that energy storage device 52 requires additional electrical energy to power locomotive 16, such as to complete a trip to a particular destination. For example, controller 58 may determine that locomotive 16 will need to acquire a threshold amount of electrical energy from energy exchange station 66 in order to have enough energy to subsequently power locomotive 16 through the unpowered section 20 that follows the current powered section 18. Based on this, controller 58 may determine that the transmission path should be from energy storage device 30 of energy exchange station 66, through electrical contacts 26 and 46, to energy storage device 52 on locomotive 16. For example, power source 32 may create electrical energy that is stored in energy storage device 30 at trackside location 36. The electrical energy may subsequently be transmitted to energy storage device 52 via the transmission path. In other embodiments, the transmission path may include power source 32 directly transmitting electrical energy to energy storage device 52 without storing the electrical energy in energy storage device 30.

As locomotive 16 enters powered section 18 associated with energy exchange station 66, electrical contact 44 may be electrically connected to electrical contact 24 (e.g., charging shoe 46 connects to electrified rail 26) and power transmission via the transmission path may be initiated. Power transmission may continue until locomotive 16 leaves powered section 18 and enters the next unpowered section 20 or a threshold power transmission is reached. Locomotive 16 may then travel on unpowered section 20 via electrical energy received from energy exchange station 66.

In other instances, controller 60 (or controller 64 at control station 62) may determine that energy storage device 30 requires additional electrical energy and arrange for locomotive 16 to transmit electrical energy to energy exchange station 22 (e.g., energy exchange station 70) as it passes through a powered section 18. In this example, controller 60 may determine that the transmission path should be from RBS 54 onboard locomotive 16 to energy storage device 30 of energy exchange station 70, via electrical contacts 28 and 48. In other embodiments, the transmission path may include energy storage device 52, which may receive generated electrical energy from RBS 54 and transmit it offboard to energy storage device 30 when needed. As locomotive 16 enters powered section 18 associated with energy exchange station 70, power transmission via the transmission path may be initiated.

During transmission, electrical energy may be generated onboard locomotive 16 by RBS 54. For example, the powered section 18 associated with energy exchange station 70 may be a downhill track 12. Locomotive 16 may travel downhill on the track 12 and create electrical energy via RBS 54 as locomotive 16 brakes to maintain or reduce speed on the hill. As locomotive 16 travels through powered section 18, power transmission from RBS 54 to energy exchange station 70 may continue, as determined by controller 60. In this way, locomotive 16 may act as a power source to charge energy storage device 30. Power transmission may be discontinued when locomotive 16 leaves powered section 18 or a threshold power transmission is reached. A controller, such as controller 60, may subsequently direct energy storage device 30 to transmit the received electrical energy to another locomotive 16, another energy exchange station (e.g., energy exchange station 68 via global exchange system 42), or other electrical energy destination.

Energy exchange stations 22 may be configured and arranged within rail system 10 in any way to allow electrical energy to be generated, stored, and/or consumed, such as through the exemplary processes described above. It should be understood that the configurations of energy exchange stations 66, 68, and 70 are merely exemplary and that other configurations of energy exchange stations 22 within rail system 10 are possible.

The exemplary disclosed embodiments provide a rail system 10 that overcomes the problems associated with other electrical rail systems. The use of powered sections 18 and unpowered sections 20 allows for a relatively small infrastructure that reduces costs. Further, the arrangement of energy exchange stations 22 allows power sources 32, in the form of renewable energy sources 34, to be used in powering locomotives 16. The electrical energy from power sources 32, especially in the case of renewable energy sources 34, may be accumulated such that a relatively large amount of electrical energy is made available at an energy exchange station 22. In this way, locomotives 16 may rapidly receive electrical energy while they travel on track 12. In this way, locomotives may receive enough energy to travel on unpowered sections 20 while not be required to stop for charging, and thus not being out of service for periods of time. In addition, strategic placement of energy exchange stations 22 may allow for energy sharing between locomotives 16, reducing the need for energy generation from other sources.

It will be apparent to those skilled in the art that various modifications and variations can be made to the rail system of the present disclosure without departing from the scope of the disclosure. Other embodiments will be apparent to those skilled in the art from consideration of the specification and practice of the embodiments disclosed herein. It is intended that the specification and examples be considered as exemplary only, with a true scope of the disclosure being indicated by the following claims.

What is claimed is:

1. A rail system, comprising:
a track including a powered section and an unpowered section;
an electrical contact that extends along the powered section of the track;
an energy exchange station electrically connected to the electrical contact,
wherein the energy exchange station is configured to:
initiate power transmission between the energy exchange station and a rail vehicle, through the electrical contact, when the rail vehicle is on the powered section of the track; and
discontinue power transmission between the energy exchange station and the rail vehicle when the rail vehicle leaves the powered section of the track.

2. The rail system of claim 1, wherein the energy exchange station includes a power source configured to generate electrical energy to be supplied to the electrical contact.

3. The rail system of claim 2, wherein the power source is a renewable energy source.

4. The rail system of claim 2, wherein the energy exchange station further includes an energy storage device electrically connected to the power source and the electrical contact, the energy storage device configured to store electrical energy.

5. The rail system of claim 4, wherein the energy storage device is configured to:
receive electrical energy from the power source; and
transmit electrical energy to the electrical contact.

6. The rail system of claim 5, wherein the energy storage device is further configured to receive electrical energy from the electrical contact.

7. The rail system of claim 1, wherein the energy exchange station includes an energy storage device electrically connected to the electrical contact, wherein the energy storage device is configured to:
transmit electrical energy to the electrical contact; and
receive electrical energy from the electrical contact.

8. The rail system of claim 1, further including a controller in communication with the energy exchange station, wherein the controller is configured to:
determine an energy state of a rail vehicle on the track;
determine a transmission path of the power transmission based on the energy state of the rail vehicle.

9. The rail system of claim 1, wherein the electrical contact is an overhead catenary.

10. The rail system of claim 1, wherein the electrical contact is an electrified rail.

11. The rail system of claim 1, wherein a length of the unpowered section of the track is greater than a length of the powered section of the track.

12. A method of operating a rail system, comprising:
connecting an electrical contact to a rail vehicle while the rail vehicle travels on a powered section of a track;
initiating power transmission between an energy exchange station and the rail vehicle, through the electrical contact, while the rail vehicle travels on the powered section of the track; and
discontinuing power transmission between the energy exchange station and the rail vehicle and disconnecting the electrical contact from the rail vehicle when the rail vehicle leaves the powered section of the track.

13. The method of claim 12, further including storing electrical energy for power transmission in an energy storage device.

14. The method of claim 13, wherein initiating power transmission between the energy exchange station and the rail vehicle includes transmitting electrical energy stored in the energy storage device to one of the energy exchange station and the rail vehicle.

15. The method of claim 13, further including:
determining an energy state of the energy storage device; and
determining a transmission path for power transmission based on the determined energy state.

16. An energy exchange system, comprising:
a track having a plurality of powered sections and a plurality of unpowered sections;
an energy exchange station located at each of the plurality of powered sections;
a vehicle configured to travel on the track;
a controller in communication with the energy exchange station and the vehicle, the controller configured to:
regulate energy transmission between the energy exchange station and the vehicle as the vehicle travels along the plurality of powered sections of the track.

17. The energy exchange system of claim 16, further including a power source and an energy storage device, wherein:
the power source is configured to generate electrical energy;
the energy storage device is configured to store the electrical energy; and
regulating energy transmission between the energy exchange station and the vehicle includes transmitting electrical energy between the power source and the energy storage device.

18. The energy exchange system of claim 17, wherein the power source is a component of the energy exchange station and the energy storage device is onboard the vehicle.

19. The energy exchange station of claim 17, wherein the energy storage device is a component of the energy exchange station and the power source is onboard the vehicle.

20. The energy exchange station of claim 19, wherein the power source is a regenerative braking system.
